(19) United States
(12) Patent Application Publication
(10) Pub. No.: US 2018/0006753 A1
(43) Pub. Date: Jan. 4, 2018

(54) GROUP ADDRESSED TRANSMISSION TECHNIQUES FOR DIRECTIONAL WIRELESS NETWORKS

(71) Applicant: INTEL CORPORATION, SANTA CLARA, CA (US)

(72) Inventors: Solomon Trainin, Haifa (IL); Carlos Cordeiro, Portland, OR (US)

(73) Assignee: INTEL CORPORATION, SANTA CLARA, CA (US)

(21) Appl. No.: 15/201,374

(22) Filed: Jul. 1, 2016

(51) Int. Cl. H04J 13/00; H04L 29/12; H04B 7/04; H04L 27/18; H04W 72/04; H04L 29/08; H04L 12/70

(52) U.S. Cl. CPC H04J 13/0074; H04W 72/0453; H04L 61/6022; H04L 69/323; H04B 7/04; H04L 61/2592; H04L 27/18; H04L 2012/5641

(57) ABSTRACT

Group-addressed transmission techniques for directional wireless networks are described. In one embodiment, for example, an apparatus may comprise logic to generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU, the logic to encapsulate the frame sequence in packets of a first packet sequence for transmission in a first direction and encapsulate the frame sequence in packets of a second packet sequence for transmission in a second direction, the transmission of the second packet sequence in the second direction to be initiated following completion of the transmission of the first packet sequence in the first direction. Other embodiments are described and claimed.

### TECHNICAL FIELD

Embodiments described herein generally relate to wireless communications between devices in wireless networks.

### BACKGROUND

The 60 GHz wireless communication frequency band offers substantial promise for use in accommodating the ever-growing data-rate demands of wireless communications devices and their users. The 60 GHz band contains a large amount of available bandwidth, the physical properties of signals with frequencies in the 60 GHz band render them well-suited for use in directional transmission and reception in conjunction with the application of spatial multiplexing techniques. 60 GHz-capable devices may perform directional transmission and reception using antenna arrays, such as steerable phased antenna arrays.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a communications flow.

FIG. 4 illustrates an embodiment of a first logic flow.

FIG. 5 illustrates an embodiment of a second logic flow.

FIG. 6 illustrates an embodiment of a storage medium.

FIG. 7 illustrates an embodiment of a device.

FIG. 8 illustrates an embodiment of a wireless network.

### DETAILED DESCRIPTION

Various embodiments may be generally directed to group-addressed transmission techniques for directional wireless networks. In one embodiment, for example, an apparatus may comprise a memory and logic for a wireless communication device, at least a portion of the logic comprised in circuitry coupled to the memory, the logic to generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU, the logic to encapsulate the frame sequence in packets of a first packet sequence for transmission in a first direction and encapsulate the frame sequence in packets of a second packet sequence for transmission in a second direction, the transmission of the second packet sequence in the second direction to be initiated following completion of the transmission of the first packet sequence in the first direction. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Various embodiments herein are generally directed to wireless communications systems. Some embodiments are particularly directed to wireless communications over 60 GHz frequencies. Various such embodiments may involve wireless communications performed according to one or more standards for 60 GHz wireless communications. For example, some embodiments may involve wireless communications performed according to one or more Wireless Gigabit Alliance (“WiGig”)/Institute of Electrical and Electronics Engineers (IEEE) 802.11ad standards, such as IEEE 802.11ad-2012, including their predecessors, revisions, progeny, and/or variants. Various embodiments may involve wireless communications performed according to one or more “next-generation” 60 GHz (“NG60”) wireless local area network (WLAN) communications standards, such as the IEEE 802.11ay standard that is currently under development. Some embodiments may involve wireless communications performed according to one or more millimeter-wave (mmWave) wireless communication standards. It is worthy of note that the term “60 GHz,” as it is employed in reference to various wireless communications devices, wireless communications frequencies, and wireless communications standards herein, is not intended to specifically denote a frequency of exactly 60 GHz, but rather is intended to generally refer to frequencies in, or near, the 57 GHz to 64 GHz frequency band or any nearby unlicensed band. The embodiments are not limited in this context.

Various embodiments may additionally or alternatively involve wireless communications according to one or more other wireless communication standards. Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

Further examples of wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11af, and/or IEEE 802.11ah standards, High-Efficiency Wi-Fi standards developed by the IEEE 802.11 High Efficiency WLAN (HEW) Study Group and/or IEEE 802.11 Task Group (TG) ax, Wi-Fi Alliance (WFA) wireless communication standards such as Wi-Fi, Wi-Fi Direct, Wi-Fi Direct Services, WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above. The embodiments are not limited to these examples.

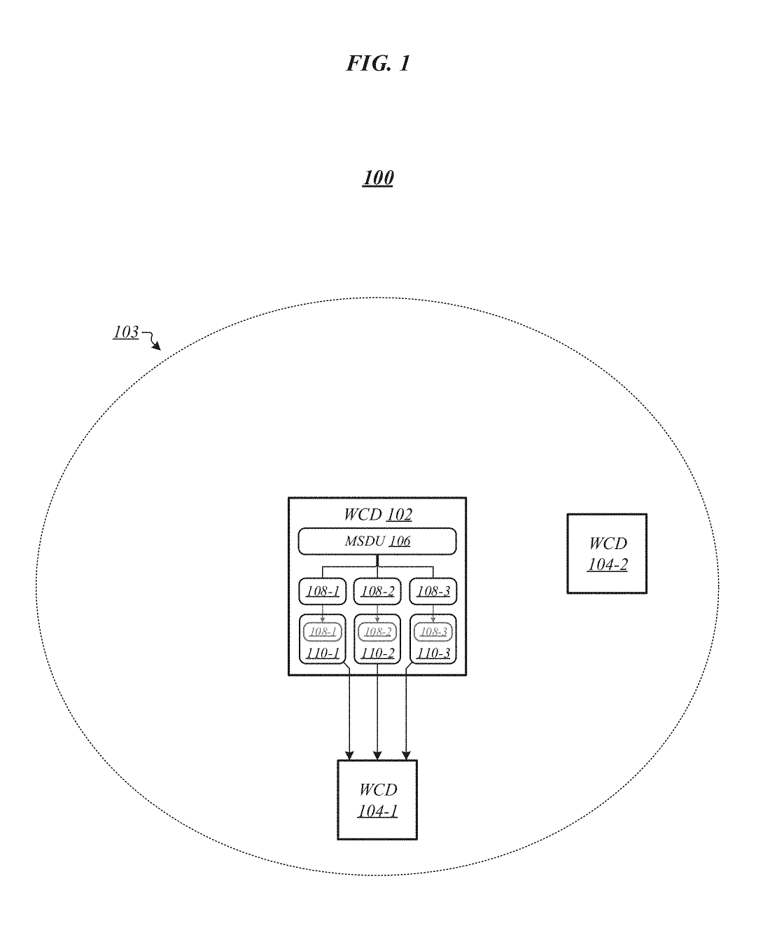

FIG. 1 illustrates an example of an operating environment 100 such as may be representative of various embodiments. In operating environment 100, wireless communication devices (WCDs) 102, 104-1, and 104-2 may communicate in a directional wireless network 103. Directional wireless network 103 may generally comprise a network in which devices may communicate using directional transmission and reception techniques. In some embodiments, wireless communication devices 104-1 and 104-2 may join directional wireless network 103 by associating with wireless communication device 102. In various embodiments, devices in directional wireless network 103 may communicate using wireless channel frequencies of the 60 GHz band. In some embodiments, directional wireless network 103 may comprise a directional multi-gigabit (DMG) or enhanced DMG (EDMG) network. In various embodiments, wireless communication device 102 may operate as a personal basic service set (PBSS) control point (PCP) or infrastructure basic service set (BSS) access point (AP) for directional wireless network 103, and wireless communication devices 104-1 and 104-2 may operate as non-PCP/AP stations (STAs). In some embodiments, wireless communication devices 104-1 and 104-2 may operate as DMG STAs or EDMG STAs. The embodiments are not limited in this context.

In operating environment 100, wireless communication device 102 may need to send a medium access control service data unit (MSDU) 106 to wireless communication device 104-1. In various embodiments, in order to send MSDUs to other devices, wireless communication device 102 may generally be operative to encapsulate those MSDUs within physical layer convergence procedure protocol data units (PPDUs) for transmission to such other devices. In some embodiments, when sending a large MSDU, wireless communication device 102 may divide that MSDU into multiple MSDU fragments, and encapsulate each such fragment in a separate respective PPDU. For example, as shown in FIG. 1, wireless communication device 102 may divide MSDU 106 into MSDU fragments 108-1, 108-2, and 108-3, which it may then encapsulate within respective PPDUs 110-1, 110-2, and 110-3 for transmission to wireless communication device 104-1. An MSDU that is divided in such fashion may be referred to as a fragmented MSDU.

In various embodiments, it may be desirable that wireless communication device 102 have the ability to send group-addressed MSDUs, which may generally comprise MSDUs that are addressed to multiple devices in directional wireless network 103. In some embodiments, it may also be desirable that this ability to send group-addressed MSDUs be applicable to fragmented MSDUs, such that wireless communication device 102 can address a fragmented MSDU to multiple devices in directional wireless network 103. In various embodiments, it may be desirable that wireless communication device 102 be able to address a fragmented MSDU to a group of devices that includes devices located in different respective directions relative to wireless communication device 102. For example, in operating environment 100, it may be desirable that wireless communication device 102 be able to address MSDU 106 to both wireless communication device 104-1 and wireless communication device 104-2. The embodiments are not limited to this example.

Disclosed herein are group-addressed transmission techniques that may be implemented in some embodiments in order to support group-addressing of fragmented MSDUs in directional networks such as directional wireless network 103. According to various such techniques, after generating a frame sequence comprising a set of fragments of an MSDU that is to be addressed to a group of remote devices, a transmitting device may encapsulate the frame sequence in a first packet sequence for transmission in a first direction and encapsulate the frame sequence in a second packet sequence for transmission in a second direction. In some embodiments, the transmitting device may be configured to complete the transmission of the entire first packet sequence before initiating transmission of the second packet sequence. In various embodiments, the frame sequence may comprise a source identification frame followed by a set of fragment frames comprising the set of MSDU fragments. In some embodiments, the source identification frame may comprise an identifier, such as an address, that is associated with the transmitting device. In various embodiments, the information comprised in the source identification frame may enable receiving devices to identify the transmitting device and configure their receive antennas appropriately for directional reception from the transmitting device. In some embodiments, the transmitting device may be configured such that if it needs to send a second group-addressed fragmented MSDU to the same group of remote devices, it will wait until completion of the transmission of the first group-addressed fragmented MSDU in all necessary directions before initiating transmission of the second group-addressed fragmented MSDU. The embodiments are not limited in this context.

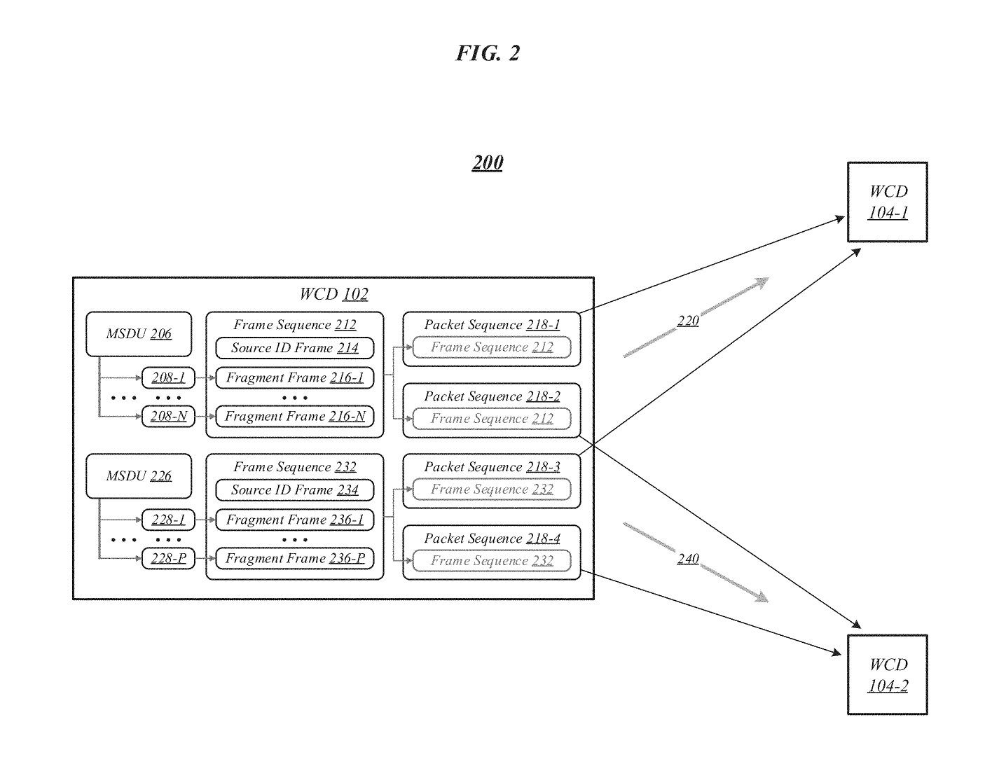

FIG. 2 illustrates an example of an operating environment 200 that may be representative of the implementation of one or more of the disclosed group-addressed transmission techniques according to various embodiments. In operating environment 200, wireless communication device 102 may determine to send MSDUs 206 and 226 to a plurality of remote devices as group-addressed fragmented MSDUs (GAFMs). The plurality of remote devices to which MSDUs 206 and 226 are to be sent may be referred to as the addressee group for MSDUs 206 and 226. In this example, the addressee group for MSDUs 206 and 226 may include wireless communication devices 104-1 and 104-2. In some embodiments, the addressee group for MSDUs 206 and 226 may include one or more additional devices. The embodiments are not limited in this context.

In various embodiments, in order to send MSDU 206 as a GAFM, wireless communication device 102 may be operative to generate a frame sequence 212. In some embodiments, frame sequence 212 may comprise a source identification frame 214 and a plurality of fragment frames 216-1 to 216-N, where N is an integer greater than 1. Source identification frame 214 may generally comprise a frame containing an identifier associated with wireless communication device 102. In various embodiments, the identifier may comprise an address, such as a medium access control (MAC) address, associated with wireless communication device 102. In some embodiments, the identifier may be comprised within a transmitter address field of source identification frame 214. In various embodiments, source identification frame 214 may comprise a short frame, such as a frame featuring no payload.

In some embodiments, wireless communication device 102 may be operative to divide MSDU 206 into a plurality of MSDU fragments 208-1 to 208-N, and each one of fragment frames 216-1 to 216-N may comprise a respective one of MSDU fragments 208-1 to 208-N. In various embodiments, each one of MSDU fragments 208-1 to 208-N may constitute a payload of a respective one of fragment frames 216-1 to 216-N. In some embodiments, each one of fragment frames 216-1 to 216-N may contain an identifier, such as a group address, associated with the addressee group for MSDU 206. In various embodiments, the identifier may be comprised within a respective receiver address field of each one of fragment frames 216-1 to 216-N. In some embodiments, each one of fragment frames 216-1 to 216-N may contain a sequence number associated with MSDU 206. In various embodiments, each one of fragment frames 216-1 to 216-N may contain a respective fragment number associated with that one of fragment frames 216-1 to 216-N. In some embodiments, source identification frame 214 and fragment frames 216-1 to 216-N may comprise MAC protocol data units (MPDUs). The embodiments are not limited in this context.

In various embodiments, in order send to MSDU 226 as a GAFM, wireless communication device 102 may be operative to generate a frame sequence 232. In some embodiments, frame sequence 232 may comprise a source identification frame 234 and a plurality of fragment frames 236-1 to 236-P, where P is an integer greater than 1 and may or may not be the same as N. Source identification frame 234 may generally comprise a frame containing an identifier associated with wireless communication device 102. In various embodiments, the identifier comprised in source identification frame 234 may be the same as the identifier comprise in source identification frame 214. In some embodiments, the identifier may be comprised within a transmitter address field of source identification frame 234. In various embodiments, source identification frame 234 may comprise a short frame, such as a frame featuring no payload.

In some embodiments, wireless communication device 102 may be operative to divide MSDU 226 into a plurality of MSDU fragments 228-1 to 228-P, and each one of fragment frames 236-1 to 236-P may comprise a respective one of MSDU fragments 228-1 to 228-P. In various embodiments, each one of MSDU fragments 228-1 to 228-P may comprise a payload of a respective one of fragment frames 236-1 to 236-P. In some embodiments, each one of fragment frames 236-1 to 236-P may contain an identifier, such as a group address, associated with the addressee group for MSDU 226. In various embodiments, the identifier may be comprised within a respective receiver address field of each of fragment frames 236-1 to 236-P. In some embodiments, each one of fragment frames 236-1 to 236-P may contain a sequence number associated with MSDU 226. In various embodiments, each one of fragment frames 236-1 to 236-P may contain a respective fragment number associated with that one of fragment frames 236-1 to 236-P. In some embodiments, source identification frame 234 and fragment frames 236-1 to 236-P may comprise MPDUs. The embodiments are not limited in this context.

In various embodiments, wireless communication device 102 may initiate a first GAFM transmission procedure in order to send frame sequence 212 to the addressee group for MSDU 206. In some embodiments, according to the first GAFM transmission procedure, wireless communication device 102 may be operative to transmit packets comprising frame sequence 212 in a first direction 220 during a first packet transmission process and transmit packets comprising frame sequence 212 in a second direction 240 during a second packet transmission process. In various embodiments, the transmitted packets may comprise PPDUs. In some embodiments, directions 220 and 240 may generally correspond to relative directions of the locations of respective subsets of the remote devices comprised in the addressee group for MSDU 206. For example, direction 220 may generally correspond to the direction of the location of wireless communication device 104-1 relative to the location of wireless communication device 102, and direction 240 may generally correspond to the direction of the location of wireless communication device 104-2 relative to the location of wireless communication device 102. In various embodiments, directions 220 and 240 may comprise different respective transmit sectors of wireless communication device 102. The embodiments are not limited in this context.

In some embodiments, wireless communication device 102 may be operative to encapsulate the plurality of frames of frame sequence 212 in a respective plurality of packets of a packet sequence 218-1, which it may transmit in direction 220 during the first packet transmission process. In various embodiments, source identification frame 214 may be encapsulated in a first packet of packet sequence 218-1, and fragment frames 216-1 to 216-N may be encapsulated in the remaining packets of packet sequence 218-1. The embodiments are not limited in this context.

In some embodiments, wireless communication device 104-1 may be operative to identify wireless communication device 102 as the source of packet sequence 218-1 based on the source identification frame 214 comprised in the first packet of packet sequence 218-1. In various embodiments, wireless communication device 104-1 may then be operative to identify an appropriate receive antenna configuration for directional reception from wireless communication device 102, such as it may have previously determined via an exchange of beamforming messages with wireless communication device 102, for example. In some embodiments, wireless communication device 104-1 may identify an appropriate receive sector for directional reception from wireless communication device 102 and determine the appropriate receive antenna configuration based on the identified receive sector. In various embodiments, wireless communication device 104-1 may implement the identified receive antenna configuration in order to directionally receive the remaining packets of packet sequence 218-1 from wireless communication device 102. The embodiments are not limited in this context.

In some embodiments, wireless communication device 102 may also be operative to encapsulate the plurality of frames of frame sequence 212 in a respective plurality of packets of a packet sequence 218-2, which it may transmit in direction 240 during the second packet transmission process. In various embodiments, source identification frame 214 may be encapsulated in a first packet of packet sequence 218-2, and fragment frames 216-1 to 216-N may be encapsulated in the remaining packets of packet sequence 218-2. The embodiments are not limited in this context.

In some embodiments, wireless communication device 104-2 may be operative to identify wireless communication device 102 as the source of packet sequence 218-2 based on a source identification frame 214 comprised in the first packet of packet sequence 218-2. In various embodiments, wireless communication device 104-2 may then be operative to identify an appropriate receive antenna configuration for directional reception from wireless communication device 102, such as it may have previously determined via an exchange of beamforming messages with wireless communication device 102, for example. In some embodiments, wireless communication device 104-2 may identify an appropriate receive sector for directional reception from wireless communication device 102 and determine the appropriate receive antenna configuration based on the identified receive sector. In various embodiments, wireless communication device 104-2 may implement that identified receive antenna configuration in order to directionally receive the remaining packets of packet sequence 218-2 from wireless communication device 102. The embodiments are not limited in this context.

In some embodiments, wireless communication device 102 may initiate a second GAFM transmission procedure in order to send frame sequence 232 to the addressee group for MSDU 226, which in this example is the same as the addressee group for MSDU 206. In various embodiments, according to the second GAFM transmission procedure, wireless communication device 102 may be operative to transmit packets comprising frame sequence 232 in direction 220 during a third packet transmission process and transmit packets comprising frame sequence 232 in direction 240 during a fourth packet transmission process. In some embodiments, the transmitted packets may comprise PPDUs. The embodiments are not limited in this context.

In various embodiments, wireless communication device 102 may be operative to encapsulate the plurality of frames of frame sequence 232 in a respective plurality of packets of a packet sequence 218-3, which it may transmit in direction 220 during the third packet transmission process. In some embodiments, source identification frame 234 may be encapsulated in a first packet of packet sequence 218-3, and fragment frames 236-1 to 236-P may be encapsulated in the remaining packets of packet sequence 218-3. The embodiments are not limited in this context.

In various embodiments, wireless communication device 104-1 may be operative to identify wireless communication device 102 as the source of packet sequence 218-3 based on a source identification frame 234 comprised in the first packet of packet sequence 218-3. In some embodiments, wireless communication device 104-1 may then be operative to identify an appropriate receive antenna configuration for directional reception from wireless communication device 102, such as it may have previously determined via an exchange of beamforming messages with wireless communication device 102, for example. In various embodiments, wireless communication device 104-1 may implement the identified receive antenna configuration in order to directionally receive the remaining packets of packet sequence 218-3 from wireless communication device 102. In some embodiments, this receive antenna configuration may match the receive antenna configuration used for directional reception of packets of packet sequence 218-1. In various other embodiments, this receive antenna configuration may differ from that used for directional reception of packets of packet sequence 218-1. The embodiments are not limited in this context.

In some embodiments wireless communication device 102 may also be operative to encapsulate the plurality of frames of frame sequence 232 in a respective plurality of packets of a packet sequence 218-4, which it may transmit in direction 240 during the fourth packet transmission process. In various embodiments, source identification frame 234 may be encapsulated in a first packet of packet sequence 218-4, and fragment frames 236-1 to 236-P may be encapsulated in the remaining packets of packet sequence 218-4. The embodiments are not limited in this context.

In some embodiments, wireless communication device 104-2 may be operative to identify wireless communication device 102 as the source of packet sequence 218-4 based on a source identification frame 234 comprised in the first packet of packet sequence 218-4. In various embodiments, wireless communication device 104-2 may then be operative to identify an appropriate receive antenna configuration for directional reception from wireless communication device 102, such as it may have previously determined via an exchange of beamforming messages with wireless communication device 102, for example. In some embodiments, wireless communication device 104-2 may implement the identified receive antenna configuration in order to directionally receive the remaining packets of packet sequence 218-4 from wireless communication device 102. In various embodiments, this receive antenna configuration may match the receive antenna configuration used for directional reception of packets of packet sequence 218-2. In some other embodiments, this receive antenna configuration may differ from that used for directional reception of packets of packet sequence 218-2. The embodiments are not limited in this context.

In various embodiments, with respect to any given GAFM to be transmitted in multiple directions, wireless communication device 102 may be configured to transmit all of the fragments of the GAFM in one direction before beginning transmission of the fragments in a next direction. In such embodiments, during the first GAFM transmission procedure according to which it sends MSDU 206 in the example of FIG. 2, wireless communication device 102 may wait until it has completed the first transmission process—and has thus transmitted the entirety of packet sequence 218-1 in direction 220—before initiating the second transmission process to transmit packet sequence 218-2 in direction 240. Likewise, during the second GAFM transmission procedure according to which it sends MSDU 226, wireless communication device 102 may wait until it has completed the third transmission process—and has thus transmitted the entirety of packet sequence 218-3 in direction 220—before initiating the second transmission process to transmit packet sequence 218-4 in direction 240. In some embodiments, this approach may minimize or reduce the number of times that wireless communication device 102 has to change transmission direction—and thus modify its transmit antenna configuration—in conjunction with sending MSDUs 206 and 226 to the addressee group including wireless communication devices 104-1 and 104-2. In various embodiments, this approach may also enable addressee devices located in direction 220 to reconstruct MSDUs 206 more quickly. The embodiments are not limited in this context.

In some embodiments, with respect to any particular set of multiple GAFMs to be sent to a same addressee group, wireless communication device 102 may be configured to transmit all of the fragments of one GAFM in all necessary directions before beginning transmission of the fragments of a next GAFM. In such embodiments, in the context of operating environment 200, wireless communication device 102 may wait until it has completed the first GAFM transmission procedure—and has thus transmitted all of the fragments of MSDU 206 in both direction 220 and direction 240—before initiating the second GAFM transmission procedure to transmit the fragments of MSDU 226 in directions 220 and 240. The embodiments are not limited in this context.

In various embodiments, the respective initial packets of packet sequences 218-1, 218-2, 218-3, and 218-4 may be transmitted according to a modulation and coding scheme (MCS) for a control physical layer (PHY). In some embodiments, the control PHY may comprise a DMG control PHY. In various embodiments, the control PHY MCS may correspond to an MCS index value of 0. In some embodiments, the respective initial packets of packet sequences 218-1, 218-2, 218-3, and 218-4 may be generated using differential binary phase-shift keying (DBPSK). The embodiments are not limited in this context.

In various embodiments, each one of fragment frames 216-1 to 216-N and fragment frames 236-1 to 236-P may be encapsulated in a respective packet generated for transmission according to an MCS for an orthogonal frequency division multiplexing (OFDM) PHY (such as a DMG OFDM PHY), a single carrier (SC) PHY (such as a DMG SC PHY), or a low-power SC PHY (such as a DMG low-power SC PHY). In some embodiments, each one of fragment frames 216-1 to 216-N and fragment frames 236-1 to 236-P may be encapsulated in a respective packet generated for transmission using π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM. In various embodiments, each one of fragment frames 216-1 to 216-N and fragment frames 236-1 to 236-P may be encapsulated in a respective packet generated for transmission according to an MCS corresponding to an MCS index value that is greater than 0. The embodiments are not limited in this context.

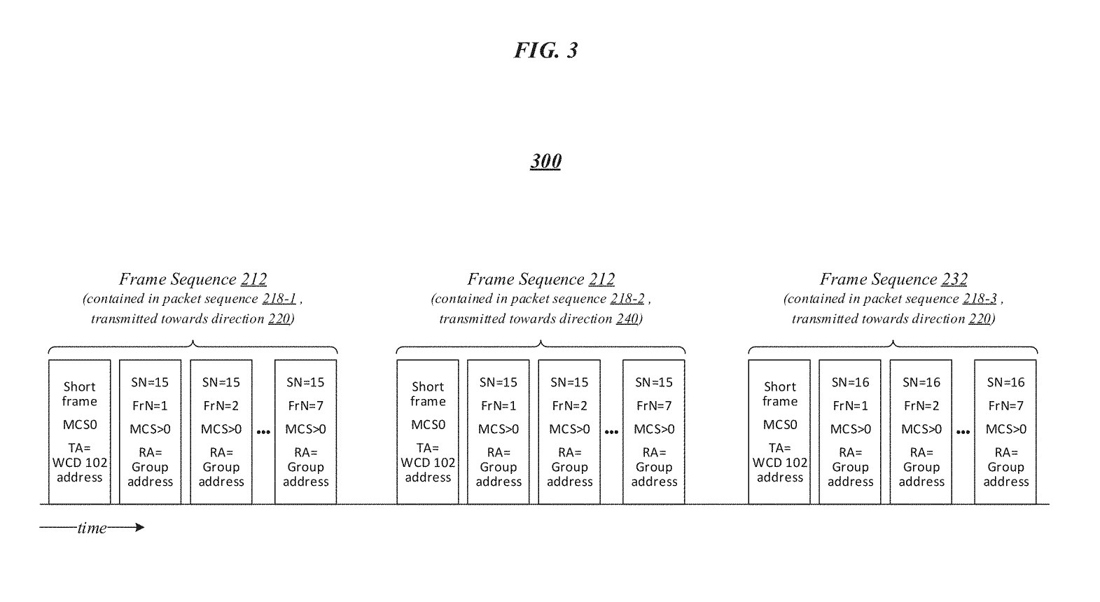

FIG. 3 illustrates an example of a communication flow 300 that may be representative of the implementation of one or more of the disclosed group-addressed transmission techniques according to some embodiments. More particularly, communication flow 300 may be representative of an example of a series of transmissions that may be performed in operating environment 200 of FIG. 2 by wireless communication device 102 according to various embodiments. The example depicted in FIG. 3 may correspond to some embodiments in which MSDUs 206 and 226 are both divided into seven fragments, and thus both N and P are equal to 7.

As shown in FIG. 3, according to communications flow 300, frame sequence 212 may first be sent towards direction 220 by transmitting packet sequence 218-1 towards direction 220. The first frame of frame sequence 212 may comprise a short frame in which a transmitting STA address (TA) field contains an address associated with wireless communication device 102, and the packet comprising that short frame may be transmitted first, using MCS 0. In various embodiments, the address associated with wireless communication device 102 may comprise a 48-bit address. Each remaining frame of frame sequence 212 may contain a sequence number (SN) associated with MSDU 206, which in this example may be equal to 15. Each remaining frame of frame sequence 212 may also contain a respective fragment number (FrN), as well as a receiving STA address (RA) field that contains a group address associated with the addressee group of MSDU 206. In some embodiments, the group address may comprise a 48-bit address. The packets comprising these remaining frames may be transmitted using an MCS>0, in order of ascending FrN (from 1 to 7).

After the entirety of frame sequence 212 has been sent towards direction 220, frame sequence 212 may be sent towards direction 240 by transmitting packet sequence 218-2 towards direction 240. Once again, the packet comprising the short frame may be transmitted first, using MCS 0, and the packets comprising the remaining frames may be transmitted in order of ascending FrN, using an MCS>0. After the entirety of frame sequence 212 has been sent towards direction 240, frame sequence 232 may be sent towards direction 220 by transmitting packet sequence 218-3 towards direction 220. As shown in FIG. 3, the frames of frame sequence 232 may comprise an SN of 16, which may comprise an SN associated with MSDU 226. As was the case with respect to frame sequence 212, a packet comprising a short frame of frame sequence 232 may be transmitted first, using MCS 0, followed by the remaining frames of frame sequence 232, which may be transmitted using an MCS>0, in ascending order of FrN. Although not depicted in FIG. 3 due to spatial limitations, after the entirety of frame sequence 232 has been sent towards direction 220, it may be sent towards direction 240 by transmitting packet sequence 218-4 towards direction 240. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

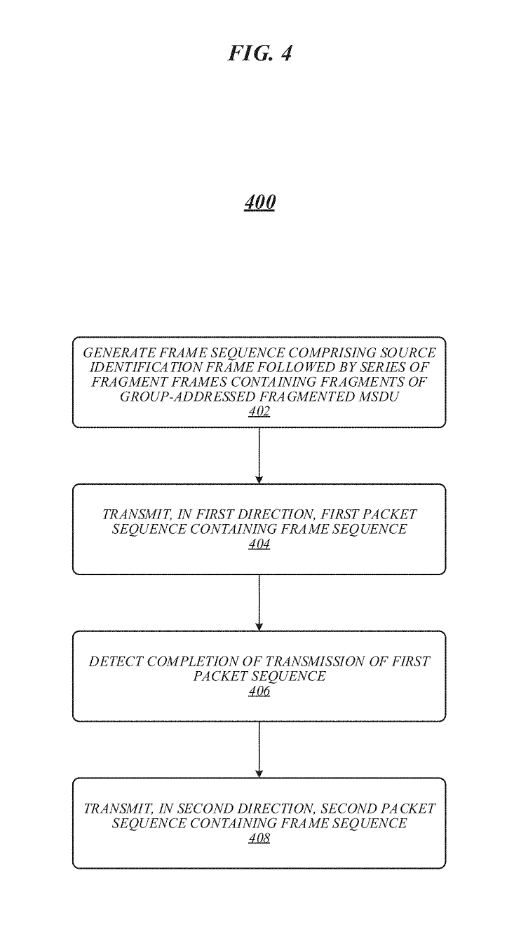

FIG. 4 illustrates an example of a logic flow 400 that may be representative of the implementation of one or more of the disclosed group-addressed transmission techniques according to various embodiments. As shown in FIG. 4, a frame sequence may be generated at 402 that comprises a source identification frame followed by a series of fragment frames containing fragments of a group-addressed fragmented MSDU. For example, in operating environment 200 of FIG. 2, wireless communication device 102 may be operative to generate frame sequence 212, which may comprise source identification frame 214 followed by fragment frames 216-1 to 216-N. At 404, a first packet sequence that contains the frame sequence may be transmitted in a first direction. For example, in operating environment 200 of FIG. 2, wireless communication device 102 may be operative to transmit packet sequence 218-1 in direction 220. At 406, a completion of the transmission of the first packet sequence may be detected. For example, in operating environment 200 of FIG. 2, wireless communication device 102 may be operative to determine that it has transmitted each packet of packet sequence 218-1. At 408, a second packet sequence that contains the frame sequence may be transmitted in a second direction. For example, in operating environment 200 of FIG. 2, wireless communication device 102 may be operative to transmit packet sequence 218-2 in direction 240. The embodiments are not limited to these examples.

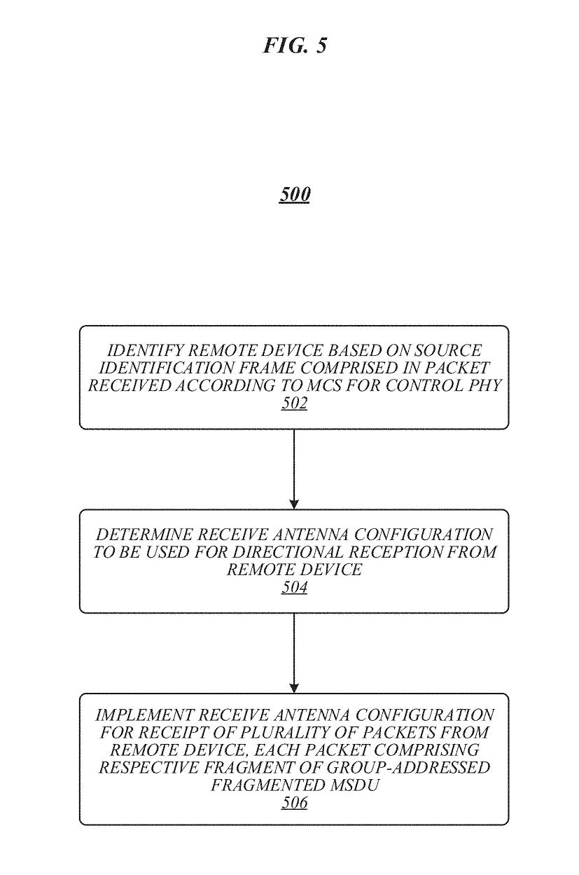

FIG. 5 illustrates an example of a logic flow 500 that may be representative of the implementation of one or more of the disclosed group-addressed transmission techniques according to some embodiments. As shown in FIG. 5, a remote device may be identified at 502 based on a source identification frame comprised in a packet received according to an MCS for a control PHY. For example, in operating environment 200 of FIG. 2, wireless communication device 104-1 may be operative to identify wireless communication device 102 based on source identification frame 214, which may be comprised in a packet that wireless communication device 104-1 receives according to an MCS for a control PHY, such as an MCS 0. At 504, a receive antenna configuration that is to be used for directional reception from the remote device may be determined For example, in operating environment 200 of FIG. 2, wireless communication device 104-1 may be operative to determine a receive antenna configuration to be used for directional reception from wireless communication device 102. At 506, the receive antenna configuration may be implemented for receipt of a plurality of packets from the remote device, where each such packet comprises a respective fragment of a group-addressed fragmented MSDU. For example, in operating environment 200 of FIG. 2, having received an initial packet of packet sequence 218-1 from wireless communication device 102 according to the MCS for the control PHY, wireless communication device 104-1 may be operative to implement a receive antenna configuration for receipt of the remaining packets of packet sequence 218-1. The embodiments are not limited to these examples.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc. The embodiments are not limited in this context.

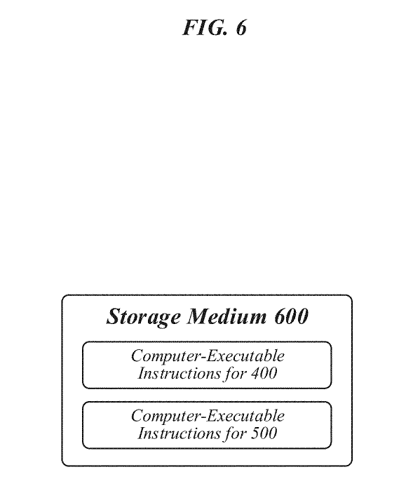

FIG. 6 illustrates an embodiment of a storage medium 600. Storage medium 600 may comprise any non-transitory computer-readable storage medium or machine-readable storage medium, such as an optical, magnetic or semiconductor storage medium. In various embodiments, storage medium 600 may comprise an article of manufacture. In some embodiments, storage medium 600 may store computer-executable instructions, such as computer-executable instructions to implement one or both of logic flow 400 of FIG. 4 and logic flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

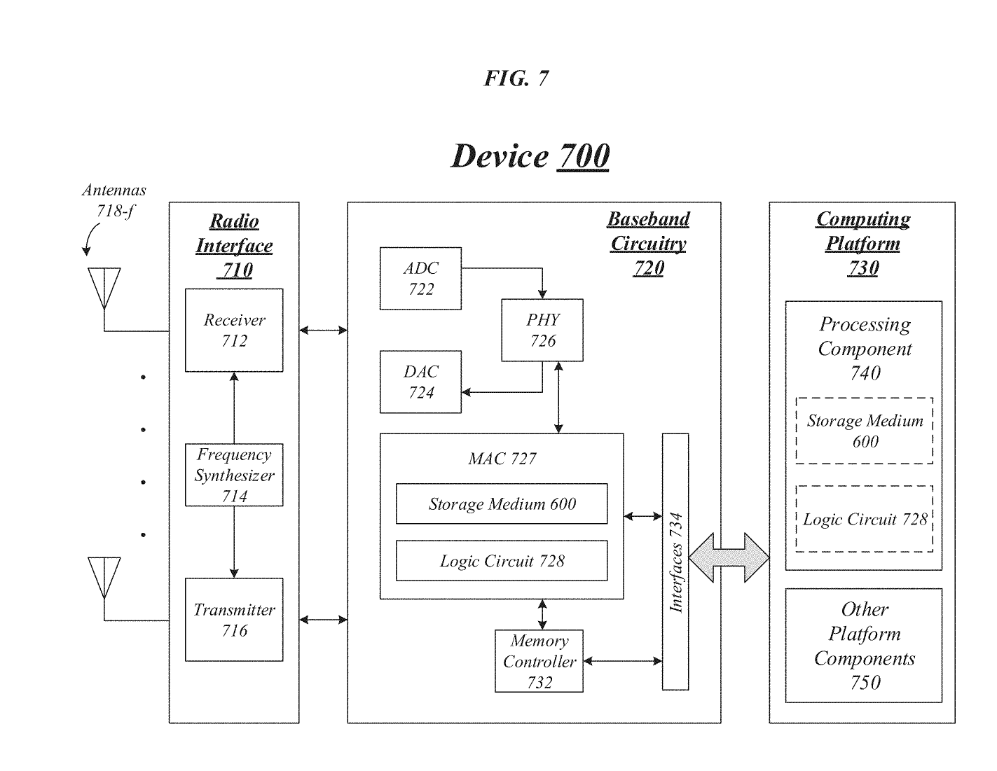

FIG. 7 illustrates an embodiment of a communications device 700 that may implement one or more of wireless communication devices 102, 104-1, and 104-2 of FIGS. 1-2, logic flow 400 of FIG. 4, logic flow 500 of FIG. 5, and storage medium 600 of FIG. 6. In various embodiments, device 700 may comprise a logic circuit 728. The logic circuit 728 may include physical circuits to perform operations described for one or more of wireless communication devices 102, 104-1, and 104-2 of FIGS. 1-2, logic flow 400 of FIG. 4, and logic flow 500 of FIG. 5, for example. As shown in FIG. 7, device 700 may include a radio interface 710, baseband circuitry 720, and computing platform 730, although the embodiments are not limited to this configuration.

The device 700 may implement some or all of the structure and/or operations for one or more of wireless communication devices 102, 104-1, and 104-2 of FIGS. 1-2, logic flow 400 of FIG. 4, logic flow 500 of FIG. 5, storage medium 600 of FIG. 6, and logic circuit 728 in a single computing entity, such as entirely within a single device. Alternatively, the device 700 may distribute portions of the structure and/or operations for one or more of wireless communication devices 102, 104-1, and 104-2 of FIGS. 1-2, logic flow 400 of FIG. 4, logic flow 500 of FIG. 5, storage medium 600 of FIG. 6, and logic circuit 728 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 710 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 710 may include, for example, a receiver 712, a frequency synthesizer 714, and/or a transmitter 716. Radio interface 710 may include bias controls, a crystal oscillator and/or one or more antennas 718-f. In another embodiment, radio interface 710 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 720 may communicate with radio interface 710 to process receive and/or transmit signals and may include, for example, an analog-to-digital converter 722 for down converting received signals, a digital-to-analog converter 724 for up converting signals for transmission. Further, baseband circuitry 720 may include a baseband or physical layer (PHY) processing circuit 726 for PHY link layer processing of respective receive/transmit signals. Baseband circuitry 720 may include, for example, a medium access control (MAC) processing circuit 727 for MAC/data link layer processing. Baseband circuitry 720 may include a memory controller 732 for communicating with MAC processing circuit 727 and/or a computing platform 730, for example, via one or more interfaces 734.

In some embodiments, PHY processing circuit 726 may include a frame construction and/or detection module, in combination with additional circuitry such as a buffer memory, to construct and/or deconstruct communication frames. Alternatively or in addition, MAC processing circuit 727 may share processing for certain of these functions or perform these processes independent of PHY processing circuit 726. In some embodiments, MAC and PHY processing may be integrated into a single circuit.

The computing platform 730 may provide computing functionality for the device 700. As shown, the computing platform 730 may include a processing component 740. In addition to, or alternatively of, the baseband circuitry 720, the device 700 may execute processing operations or logic for one or more of wireless communication devices 102, 104-1, and 104-2 of FIGS. 1-2, logic flow 400 of FIG. 4, logic flow 500 of FIG. 5, storage medium 600 of FIG. 6, and logic circuit 728 using the processing component 740. The processing component 740 (and/or PHY 726 and/or MAC 727) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 730 may further include other platform components 750. Other platform components 750 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 700 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 700 described herein, may be included or omitted in various embodiments of device 700, as suitably desired.

Embodiments of device 700 may be implemented using single input single output (SISO) architectures. However, certain implementations may include multiple antennas (e.g., antennas 718-f) for transmission and/or reception using adaptive antenna techniques for beamforming or spatial division multiple access (SDMA) and/or using MIMO communication techniques.

The components and features of device 700 may be implemented using any combination of discrete circuitry, application specific integrated circuits (ASICs), logic gates and/or single chip architectures. Further, the features of device 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

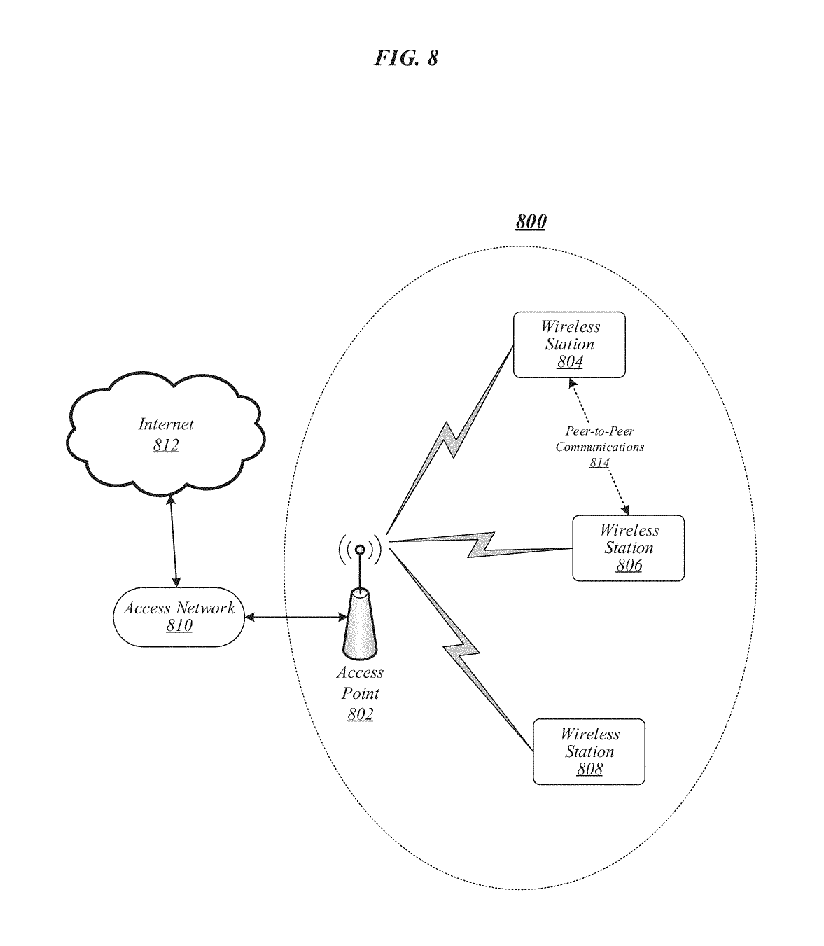

FIG. 8 illustrates an embodiment of a wireless network 800. As shown in FIG. 8, wireless network comprises an access point 802 and wireless stations 804, 806, and 808. In various embodiments, wireless network 800 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 800 may comprise another type of wireless network, and/or may implement other wireless communications standards. In various embodiments, for example, wireless network 800 may comprise a WWAN or WPAN rather than a WLAN. The embodiments are not limited to this example.

In some embodiments, wireless network 800 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 804, 806, and 808 may communicate with access point 802 in order to obtain connectivity to one or more external data networks. In some embodiments, for example, wireless stations 804, 806, and 808 may connect to the Internet 812 via access point 802 and access network 810. In various embodiments, access network 810 may comprise a private network that provides subscription-based Internet-connectivity, such as an Internet Service Provider (ISP) network. The embodiments are not limited to this example.

In various embodiments, two or more of wireless stations 804, 806, and 808 may communicate with each other directly by exchanging peer-to-peer communications. For example, in the example of FIG. 8, wireless stations 804 and 806 communicate with each other directly by exchanging peer-to-peer communications 814. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is an apparatus, comprising a memory, and logic for a wireless communication device, at least a portion of the logic comprised in circuitry coupled to the memory, the logic to generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU, encapsulate the frame sequence in packets of a first packet sequence for transmission in a first direction, and encapsulate the frame sequence in packets of a second packet sequence for transmission in a second direction, the transmission of the second packet sequence in the second direction to be initiated following completion of the transmission of the first packet sequence in the first direction.

Example 2 is the apparatus of Example 1, the source identification frame to be encapsulated in an initial packet of the first packet sequence and an initial packet of the second packet sequence.

Example 3 is the apparatus of any of Examples 1 to 2, the respective initial packets of the first and second packet sequences to be generated for transmission according to a modulation and coding scheme (MCS) for a control physical layer (PHY).

Example 4 is the apparatus of Example 3, the control PHY to comprise a directional multi-gigabit (DMG) control PHY.

Example 5 is the apparatus of any of Examples 3 to 4, an MCS index associated with the MCS for the control PHY to comprise a value of 0.

Example 6 is the apparatus of any of Examples 1 to 5, the respective initial packets of the first and second packet sequences to be generated for transmission using differential binary phase-shift keying (DBPSK).

Example 7 is the apparatus of any of Examples 1 to 6, the fragment frames to be encapsulated in packets generated for transmission according to a modulation and coding scheme (MCS) for an orthogonal frequency division multiplexing (OFDM) PHY, a single carrier (SC) PHY, or a low-power SC PHY.

Example 8 is the apparatus of any of Examples 1 to 7, the fragment frames to be encapsulated in packets generated for transmission using π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 9 is the apparatus of any of Examples 1 to 8, the fragment frames to be encapsulated in packets generated for transmission according to a modulation and coding scheme (MCS) corresponding to an MCS index value that is greater than 0.

Example 10 is the apparatus of any of Examples 1 to 9, the first direction to comprise a direction associated with locations of one or more members of the addressee group, the second direction to comprise a direction associated with at least one other member of the addressee group.

Example 11 is the apparatus of any of Examples 1 to 10, the first and second directions to comprise different respective transmit sectors of the wireless communication device.

Example 12 is the apparatus of any of Examples 1 to 11, the logic to generate a second frame sequence for transmission from the wireless communication device to the addressee group, the transmission of the second frame sequence to be initiated following the transmission of the first frame sequence.

Example 13 is the apparatus of Example 12, the second frame sequence to comprise a second source identification frame followed by a second series of fragment frames comprising fragments of a second group-addressed fragmented MSDU.

Example 14 is the apparatus of any of Examples 1 to 13, the source identification frame to comprise an identifier associated with the wireless communication device.

Example 15 is the apparatus of Example 14, the identifier to comprise an address associated with the wireless communication device.

Example 16 is the apparatus of Example 15, the address to comprise a medium access control (MAC) address.

Example 17 is the apparatus of any of Examples 15 to 16, the address to be comprised in a transmitting station (STA) address (TA) field of the source identification frame.

Example 18 is the apparatus of any of Examples 1 to 17, each of the series of fragment frames to comprise an identifier associated with the addressee group.

Example 19 is the apparatus of Example 18, the identifier associated with the addressee group to comprise a group address.

Example 20 is the apparatus of Example 19, the group address to be comprised in a respective receiving station (STA) address (RA) field of each of the series of fragment frames.

Example 21 is the apparatus of any of Examples 1 to 20, each of the series of fragment frames to comprise a sequence number (SN) field indicating a sequence number associated with the group-addressed fragmented MSDU.

Example 22 is the apparatus of any of Examples 1 to 21, each one of the series of fragment frames to comprise a respective fragment number (FrN) field indicating a fragment number associated with an MSDU fragment comprised in that fragment frame.

Example 23 is the apparatus of any of Examples 1 to 22, the first and second packet sequences to be transmitted via one or more wireless carrier frequencies of a 60 gigahertz (GHz) frequency band.

Example 24 is the apparatus of any of Examples 1 to 23, the wireless communication device to comprise a personal basic service set control point (PCP) or an access point (AP).

Example 25 is the apparatus of any of Examples 1 to 24, the addressee group to comprise a plurality of stations (STAs).

Example 26 is the apparatus of Example 25, the plurality of STAs to include one or more directional multi-gigabit (DMG) STAs.

Example 27 is the apparatus of any of Examples 25 to 26, the plurality of STAs to include one or more enhanced directional multi-gigabit (EDMG) STAs.

Example 28 is a system, comprising an apparatus according to any of Examples 1 to 27, and at least one radio frequency (RF) transceiver.

Example 29 is the system of Example 28, comprising at least one processor.

Example 30 is the system of any of Examples 28 to 29, comprising at least one RF antenna.

Example 31 is an apparatus, comprising a memory, and logic for a wireless communication device, at least a portion of the logic comprised in circuitry coupled to the memory, the logic to identify a remote device based on source identification frame comprised in a packet received according to a modulation and coding scheme (MCS) for a control physical layer (PHY), determine a receive antenna configuration to be used for directional reception from the remote device, and implement the receive antenna configuration for receipt of a plurality of packets from the remote device, each one of the plurality of packets to comprise a respective one of a plurality of fragment frames containing fragments of a group-addressed fragmented medium access control service data unit (MSDU).

Example 32 is the apparatus of Example 31, the control PHY to comprise a directional multi-gigabit (DMG) control PHY.

Example 33 is the apparatus of any of Examples 31 to 32, an MCS index associated with the MCS for the control PHY to comprise a value of 0.

Example 34 is the apparatus of any of Examples 31 to 33, the MCS for the control PHY to utilize differential binary phase-shift keying (DBPSK).

Example 35 is the apparatus of any of Examples 31 to 34, each of the plurality of packets to be received according to a modulation and coding scheme (MCS) for an orthogonal frequency division multiplexing (OFDM) PHY, a single carrier (SC) PHY, or a low-power SC PHY.

Example 36 is the apparatus of any of Examples 31 to 35, each of the plurality of packets to be received according to a modulation and coding scheme (MCS) utilizing π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 37 is the apparatus of any of Examples 31 to 36, each of the plurality of packets to be received according to a modulation and coding scheme (MCS) corresponding to an MCS index value that is greater than 0.

Example 38 is the apparatus of any of Examples 31 to 37, the wireless communication device to comprise a member of an addressee group for the group-addressed fragmented MSDU.

Example 39 is the apparatus of any of Examples 31 to 38, the logic to identify a receive sector to be used for directional reception from the remote device, and determine the receive antenna configuration based on the identified receive sector.

Example 40 is the apparatus of any of Examples 31 to 39, the source identification frame to comprise an identifier associated with the remote device.

Example 41 is the apparatus of Example 40, the identifier to comprise an address associated with the remote device.

Example 42 is the apparatus of Example 41, the address to comprise a medium access control (MAC) address.

Example 43 is the apparatus of any of Examples 41 to 42, the address to be comprised in a transmitting station (STA) address (TA) field of the source identification frame.

Example 44 is the apparatus of any of Examples 31 to 43, each of the plurality of fragment frames to comprise an identifier associated with an addressee group for the group-addressed fragmented MSDU.

Example 45 is the apparatus of Example 44, the identifier associated with the addressee group to comprise a group address.

Example 46 is the apparatus of Example 45, the group address to be comprised in a respective receiving station (STA) address (RA) field of each of the plurality of fragment frames.

Example 47 is the apparatus of any of Examples 31 to 46, each of the plurality of fragment frames to comprise a sequence number (SN) field indicating a sequence number associated with the group-addressed fragmented MSDU.

Example 48 is the apparatus of any of Examples 31 to 47, each one of the plurality of fragment frames to comprise a respective fragment number (FrN) field indicating a fragment number associated with an MSDU fragment comprised in that fragment frame.

Example 49 is the apparatus of any of Examples 31 to 48, the plurality of packets to be received via one or more wireless carrier frequencies of a 60 gigahertz (GHz) frequency band.

Example 50 is the apparatus of any of Examples 31 to 49, the remote device to comprise a personal basic service set control point (PCP) or an access point (AP).

Example 51 is the apparatus of any of Examples 31 to 50, the wireless communication device to comprise a station (STA).

Example 52 is the apparatus of Example 51, the STA to comprise a directional multi-gigabit (DMG) STA.

Example 53 is the apparatus of Example 51, the STA to comprise an enhanced directional multi-gigabit (EDMG) STA.

Example 54 is a system, comprising an apparatus according to any of Examples 31 to 53, and at least one radio frequency (RF) transceiver.

Example 55 is the system of Example 54, comprising at least one processor.

Example 56 is the system of any of Examples 54 to 55, comprising at least one RF antenna.

Example 57 is the system of any of Examples 54 to 56, comprising a touchscreen display.

Example 58 is at least one non-transitory computer-readable storage medium comprising a set of instructions that, in response to being executed at a wireless communication device, cause the wireless communication device to generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU, encapsulate the frame sequence in packets of a first packet sequence for transmission in a first direction, and encapsulate the frame sequence in packets of a second packet sequence for transmission in a second direction, the transmission of the second packet sequence in the second direction to be initiated following completion of the transmission of the first packet sequence in the first direction.

Example 59 is the at least one non-transitory computer-readable storage medium of Example 58, the source identification frame to be encapsulated in an initial packet of the first packet sequence and an initial packet of the second packet sequence.

Example 60 is the at least one non-transitory computer-readable storage medium of any of Examples 58 to 59, the respective initial packets of the first and second packet sequences to be generated for transmission according to a modulation and coding scheme (MCS) for a control physical layer (PHY).

Example 61 is the at least one non-transitory computer-readable storage medium of Example 60, the control PHY to comprise a directional multi-gigabit (DMG) control PHY.

Example 62 is the at least one non-transitory computer-readable storage medium of any of Examples 60 to 61, an MCS index associated with the MCS for the control PHY to comprise a value of 0.

Example 63 is the at least one non-transitory computer-readable storage medium of any of Examples 58 to 62, the respective initial packets of the first and second packet sequences to be generated for transmission using differential binary phase-shift keying (DBPSK).

Example 64 is the at least one non-transitory computer-readable storage medium of any of Examples 58 to 63, the fragment frames to be encapsulated in packets generated for transmission according to a modulation and coding scheme (MCS) for an orthogonal frequency division multiplexing (OFDM) PHY, a single carrier (SC) PHY, or a low-power SC PHY.

Example 65 is the at least one non-transitory computer-readable storage medium of any of Examples 58 to 64, the fragment frames to be encapsulated in packets generated for transmission using π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 66 is the at least one non-transitory computer-readable storage medium of any of Examples 58 to 65, the fragment frames to be encapsulated in packets generated for transmission according to a modulation and coding scheme (MCS) corresponding to an MCS index value that is greater than 0.

Example 67 is the at least one non-transitory computer-readable storage medium of any of Examples 58 to 66, the first direction to comprise a direction associated with locations of one or more members of the addressee group, the second direction to comprise a direction associated with at least one other member of the addressee group.

Example 68 is the at least one non-transitory computer-readable storage medium of any of Examples 58 to 67, the first and second directions to comprise different respective transmit sectors of the wireless communication device.

Example 69 is the at least one non-transitory computer-readable storage medium of any of Examples 58 to 68, comprising instructions that, in response to being executed at the wireless communication device, cause the wireless communication device to generate a second frame sequence for transmission from the wireless communication device to the addressee group, the transmission of the second frame sequence to be initiated following the transmission of the first frame sequence.

Example 70 is the at least one non-transitory computer-readable storage medium of Example 69, the second frame sequence to comprise a second source identification frame followed by a second series of fragment frames comprising fragments of a second group-addressed fragmented MSDU.

Example 71 is the at least one non-transitory computer-readable storage medium of any of Examples 58 to 70, the source identification frame to comprise an identifier associated with the wireless communication device.

Example 72 is the at least one non-transitory computer-readable storage medium of Example 71, the identifier to comprise an address associated with the wireless communication device.

Example 73 is the at least one non-transitory computer-readable storage medium of Example 72, the address to comprise a medium access control (MAC) address.

Example 74 is the at least one non-transitory computer-readable storage medium of any of Examples 72 to 73, the address to be comprised in a transmitting station (STA) address (TA) field of the source identification frame.

Example 75 is the at least one non-transitory computer-readable storage medium of any of Examples 58 to 74, each of the series of fragment frames to comprise an identifier associated with the addressee group.

Example 76 is the at least one non-transitory computer-readable storage medium of Example 75, the identifier associated with the addressee group to comprise a group address.

Example 77 is the at least one non-transitory computer-readable storage medium of Example 76, the group address to be comprised in a respective receiving station (STA) address (RA) field of each of the series of fragment frames.

Example 78 is the at least one non-transitory computer-readable storage medium of any of Examples 58 to 77, each of the series of fragment frames to comprise a sequence number (SN) field indicating a sequence number associated with the group-addressed fragmented MSDU.

Example 79 is the at least one non-transitory computer-readable storage medium of any of Examples 58 to 78, each one of the series of fragment frames to comprise a respective fragment number (FrN) field indicating a fragment number associated with an MSDU fragment comprised in that fragment frame.

Example 80 is the at least one non-transitory computer-readable storage medium of any of Examples 58 to 79, the first and second packet sequences to be transmitted via one or more wireless carrier frequencies of a 60 gigahertz (GHz) frequency band.

Example 81 is the at least one non-transitory computer-readable storage medium of any of Examples 58 to 80, the wireless communication device to comprise a personal basic service set control point (PCP) or an access point (AP).

Example 82 is the at least one non-transitory computer-readable storage medium of any of Examples 58 to 81, the addressee group to comprise a plurality of stations (STAs).

Example 83 is the at least one non-transitory computer-readable storage medium of Example 82, the plurality of STAs to include one or more directional multi-gigabit (DMG) STAs.

Example 84 is the at least one non-transitory computer-readable storage medium of any of Examples 82 to 83, the plurality of STAs to include one or more enhanced directional multi-gigabit (EDMG) STAs.

Example 85 is at least one non-transitory computer-readable storage medium comprising a set of instructions that, in response to being executed at a wireless communication device, cause the wireless communication device to identify a remote device based on source identification frame comprised in a packet received according to a modulation and coding scheme (MCS) for a control physical layer (PHY), determine a receive antenna configuration to be used for directional reception from the remote device, and implement the receive antenna configuration for receipt of a plurality of packets from the remote device, each one of the plurality of packets to comprise a respective one of a plurality of fragment frames containing fragments of a group-addressed fragmented medium access control service data unit (MSDU).

Example 86 is the at least one non-transitory computer-readable storage medium of Example 85, the control PHY to comprise a directional multi-gigabit (DMG) control PHY.

Example 87 is the at least one non-transitory computer-readable storage medium of any of Examples 85 to 86, an MCS index associated with the MCS for the control PHY to comprise a value of 0.

Example 88 is the at least one non-transitory computer-readable storage medium of any of Examples 85 to 87, the MCS for the control PHY to utilize differential binary phase-shift keying (DBPSK).

Example 89 is the at least one non-transitory computer-readable storage medium of any of Examples 85 to 88, each of the plurality of packets to be received according to a modulation and coding scheme (MCS) for an orthogonal frequency division multiplexing (OFDM) PHY, a single carrier (SC) PHY, or a low-power SC PHY.

Example 90 is the at least one non-transitory computer-readable storage medium of any of Examples 85 to 89, each of the plurality of packets to be received according to a modulation and coding scheme (MCS) utilizing π/2-binary phase-shift keying (π/2-BPSK), quadrature phase-shift keying (QPSK), π/2-QPSK, staggered QPSK (SQPSK), 16-quadrature amplitude modulation (QAM), n/2-16-QAM, or 64-QAM.

Example 91 is the at least one non-transitory computer-readable storage medium of any of Examples 85 to 90, each of the plurality of packets to be received according to a modulation and coding scheme (MCS) corresponding to an MCS index value that is greater than 0.

Example 92 is the at least one non-transitory computer-readable storage medium of any of Examples 85 to 91, the wireless communication device to comprise a member of an addressee group for the group-addressed fragmented MSDU.

Example 93 is the at least one non-transitory computer-readable storage medium of any of Examples 85 to 92, comprising instructions that, in response to being executed at the wireless communication device, cause the wireless communication device to identify a receive sector to be used for directional reception from the remote device, and determine the receive antenna configuration based on the identified receive sector.

Example 94 is the at least one non-transitory computer-readable storage medium of any of Examples 85 to 93, the source identification frame to comprise an identifier associated with the remote device.

Example 95 is the at least one non-transitory computer-readable storage medium of Example 94, the identifier to comprise an address associated with the remote device.

Example 96 is the at least one non-transitory computer-readable storage medium of Example 95, the address to comprise a medium access control (MAC) address.

Example 97 is the at least one non-transitory computer-readable storage medium of any of Examples 95 to 96, the address to be comprised in a transmitting station (STA) address (TA) field of the source identification frame.

Example 98 is the at least one non-transitory computer-readable storage medium of any of Examples 85 to 97, each of the plurality of fragment frames to comprise an identifier associated with an addressee group for the group-addressed fragmented MSDU.

Example 99 is the at least one non-transitory computer-readable storage medium of Example 98, the identifier associated with the addressee group to comprise a group address.

Example 100 is the at least one non-transitory computer-readable storage medium of Example 99, the group address to be comprised in a respective receiving station (STA) address (RA) field of each of the plurality of fragment frames.

Example 101 is the at least one non-transitory computer-readable storage medium of any of Examples 85 to 100, each of the plurality of fragment frames to comprise a sequence number (SN) field indicating a sequence number associated with the group-addressed fragmented MSDU.

Example 102 is the at least one non-transitory computer-readable storage medium of any of Examples 85 to 101, each one of the plurality of fragment frames to comprise a respective fragment number (FrN) field indicating a fragment number associated with an MSDU fragment comprised in that fragment frame.

Example 103 is the at least one non-transitory computer-readable storage medium of any of Examples 85 to 102, the plurality of packets to be received via one or more wireless carrier frequencies of a 60 gigahertz (GHz) frequency band.

Example 104 is the at least one non-transitory computer-readable storage medium of any of Examples 85 to 103, the remote device to comprise a personal basic service set control point (PCP) or an access point (AP).

Example 105 is the at least one non-transitory computer-readable storage medium of any of Examples 85 to 104, the wireless communication device to comprise a station (STA).

Example 106 is the at least one non-transitory computer-readable storage medium of Example 105, the STA to comprise a directional multi-gigabit (DMG) STA.

Example 107 is the at least one non-transitory computer-readable storage medium of Example 105, the STA to comprise an enhanced directional multi-gigabit (EDMG) STA.

Example 106 is a method, comprising generating a frame sequence for transmission from a wireless communication device to an addressee group of a group-addressed fragmented medium access control service data unit (MSDU), the frame sequence to comprise a source identification frame followed by a series of fragment frames comprising fragments of the group-addressed fragmented MSDU, encapsulating the frame sequence in packets of a first packet sequence for transmission in a first direction, and encapsulating the frame sequence in packets of a second packet sequence for transmission in a second direction, the transmission of the second packet sequence in the second direction to be initiated following completion of the transmission of the first packet sequence in the first direction.

Example 107 is the method of Example 106, the source identification frame to be encapsulated in an initial packet of the first packet sequence and an initial packet of the second packet sequence.

Example 108 is the method of any of Examples 106 to 107, the respective initial packets of the first and second packet sequences to be generated for transmission according to a modulation and coding scheme (MCS) for a control physical layer (PHY).

Example 109 is the method of Example 108, the control PHY to comprise a directional multi-gigabit (DMG) control PHY.

Example 110 is the method of any of Examples 108 to 109, an MCS index associated with the MCS for the control PHY to comprise a value of 0.

Example 111 is the method of any of Examples 106 to 110, the respective initial packets of the first and second packet sequences to be generated for transmission using differential binary phase-shift keying (DBPSK).

Example 112 is the method of any of Examples 106 to 111, the fragment frames to be encapsulated in packets generated for transmission according to a modulation and coding scheme (MCS) for an orthogonal frequency division multiplexing (OFDM) PHY, a single carrier (SC) PHY, or a low-power SC PHY.

Example 113 is the method of any of Examples 106 to 112, the fragment frames to be encapsulated in packets generated for transmission using π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 114 is the method of any of Examples 106 to 113, the fragment frames to be encapsulated in packets generated for transmission according to a modulation and coding scheme (MCS) corresponding to an MCS index value that is greater than 0.

Example 115 is the method of any of Examples 106 to 114, the first direction to comprise a direction associated with locations of one or more members of the addressee group, the second direction to comprise a direction associated with at least one other member of the addressee group.

Example 116 is the method of any of Examples 106 to 115, the first and second directions to comprise different respective transmit sectors of the wireless communication device.

Example 117 is the method of any of Examples 106 to 116, comprising generating a second frame sequence for transmission from the wireless communication device to the addressee group, the transmission of the second frame sequence to be initiated following the transmission of the first frame sequence.

Example 118 is the method of Example 117, the second frame sequence to comprise a second source identification frame followed by a second series of fragment frames comprising fragments of a second group-addressed fragmented MSDU.

Example 119 is the method of any of Examples 106 to 118, the source identification frame to comprise an identifier associated with the wireless communication device.

Example 120 is the method of Example 119, the identifier to comprise an address associated with the wireless communication device.

Example 121 is the method of Example 120, the address to comprise a medium access control (MAC) address.

Example 122 is the method of any of Examples 120 to 121, the address to be comprised in a transmitting station (STA) address (TA) field of the source identification frame.

Example 123 is the method of any of Examples 106 to 122, each of the series of fragment frames to comprise an identifier associated with the addressee group.

Example 124 is the method of Example 123, the identifier associated with the addressee group to comprise a group address.

Example 125 is the method of Example 124, the group address to be comprised in a respective receiving station (STA) address (RA) field of each of the series of fragment frames.

Example 126 is the method of any of Examples 106 to 125, each of the series of fragment frames to comprise a sequence number (SN) field indicating a sequence number associated with the group-addressed fragmented MSDU.

Example 127 is the method of any of Examples 106 to 126, each one of the series of fragment frames to comprise a respective fragment number (FrN) field indicating a fragment number associated with an MSDU fragment comprised in that fragment frame.

Example 128 is the method of any of Examples 106 to 127, the first and second packet sequences to be transmitted via one or more wireless carrier frequencies of a 60 gigahertz (GHz) frequency band.

Example 129 is the method of any of Examples 106 to 128, the wireless communication device to comprise a personal basic service set control point (PCP) or an access point (AP).

Example 130 is the method of any of Examples 106 to 129, the addressee group to comprise a plurality of stations (STAs).

Example 131 is the method of Example 130, the plurality of STAs to include one or more directional multi-gigabit (DMG) STAs.

Example 132 is the method of any of Examples 130 to 131, the plurality of STAs to include one or more enhanced directional multi-gigabit (EDMG) STAs.

Example 133 is at least one non-transitory computer-readable storage medium comprising a set of instructions that, in response to being executed on a computing device, cause the computing device to perform a method according to any of Examples 106 to 132.

Example 134 is an apparatus, comprising means for performing a method according to any of Examples 106 to 132.

Example 135 is a system, comprising the apparatus of Example 134, and at least one radio frequency (RF) transceiver.

Example 136 is the system of Example 135, comprising at least one processor.

Example 137 is the system of any of Examples 135 to 136, comprising at least one RF antenna.

Example 138 is a method, comprising identifying a remote device based on source identification frame comprised in a packet received by a wireless communication device according to a modulation and coding scheme (MCS) for a control physical layer (PHY), determining a receive antenna configuration to be used for directional reception from the remote device, and implementing the receive antenna configuration for receipt of a plurality of packets from the remote device, each one of the plurality of packets to comprise a respective one of a plurality of fragment frames containing fragments of a group-addressed fragmented medium access control service data unit (MSDU).

Example 139 is the method of Example 138, the control PHY to comprise a directional multi-gigabit (DMG) control PHY.

Example 140 is the method of any of Examples 138 to 139, an MCS index associated with the MCS for the control PHY to comprise a value of 0.

Example 141 is the method of any of Examples 138 to 140, the MCS for the control PHY to utilize differential binary phase-shift keying (DBPSK).

Example 142 is the method of any of Examples 138 to 141, each of the plurality of packets to be received according to a modulation and coding scheme (MCS) for an orthogonal frequency division multiplexing (OFDM) PHY, a single carrier (SC) PHY, or a low-power SC PHY.

Example 143 is the method of any of Examples 138 to 142, each of the plurality of packets to be received according to a modulation and coding scheme (MCS) utilizing π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 144 is the method of any of Examples 138 to 143, each of the plurality of packets to be received according to a modulation and coding scheme (MCS) corresponding to an MCS index value that is greater than 0.

Example 145 is the method of any of Examples 138 to 144, the wireless communication device to comprise a member of an addressee group for the group-addressed fragmented MSDU.

Example 146 is the method of any of Examples 138 to 145, comprising identifying a receive sector to be used for directional reception from the remote device, and determining the receive antenna configuration based on the identified receive sector.

Example 147 is the method of any of Examples 138 to 146, the source identification frame to comprise an identifier associated with the remote device.

Example 148 is the method of Example 147, the identifier to comprise an address associated with the remote device.

Example 149 is the method of Example 148, the address to comprise a medium access control (MAC) address.

Example 150 is the method of any of Examples 148 to 149, the address to be comprised in a transmitting station (STA) address (TA) field of the source identification frame.

Example 151 is the method of any of Examples 138 to 150, each of the plurality of fragment frames to comprise an identifier associated with an addressee group for the group-addressed fragmented MSDU.

Example 152 is the method of Example 151, the identifier associated with the addressee group to comprise a group address.

Example 153 is the method of Example 152, the group address to be comprised in a respective receiving station (STA) address (RA) field of each of the plurality of fragment frames.

Example 154 is the method of any of Examples 138 to 153, each of the plurality of fragment frames to comprise a sequence number (SN) field indicating a sequence number associated with the group-addressed fragmented MSDU.

Example 155 is the method of any of Examples 138 to 154, each one of the plurality of fragment frames to comprise a respective fragment number (FrN) field indicating a fragment number associated with an MSDU fragment comprised in that fragment frame.

Example 156 is the method of any of Examples 138 to 155, the plurality of packets to be received via one or more wireless carrier frequencies of a 60 gigahertz (GHz) frequency band.

Example 157 is the method of any of Examples 138 to 156, the remote device to comprise a personal basic service set control point (PCP) or an access point (AP).

Example 158 is the method of any of Examples 138 to 157, the wireless communication device to comprise a station (STA).

Example 159 is the method of Example 158, the STA to comprise a directional multi-gigabit (DMG) STA.

Example 160 is the method of Example 158, the STA to comprise an enhanced directional multi-gigabit (EDMG) STA.

Example 161 is at least one non-transitory computer-readable storage medium comprising a set of instructions that, in response to being executed on a computing device, cause the computing device to perform a method according to any of Examples 138 to 160.

Example 162 is an apparatus, comprising means for performing a method according to any of Examples 138 to 160.

Example 163 is a system, comprising the apparatus of Example 162, and at least one radio frequency (RF) transceiver.

Example 164 is the system of Example 163, comprising at least one processor.

Example 165 is the system of any of Examples 163 to 164, comprising at least one RF antenna.

Example 166 is the system of any of Examples 163 to 165, comprising a touchscreen display.

Example 167 is an apparatus, comprising means for generating a frame sequence for transmission from a wireless communication device to an addressee group of a group-addressed fragmented medium access control service data unit (MSDU), the frame sequence to comprise a source identification frame followed by a series of fragment frames comprising fragments of the group-addressed fragmented MSDU, means for encapsulating the frame sequence in packets of a first packet sequence for transmission in a first direction, and means for encapsulating the frame sequence in packets of a second packet sequence for transmission in a second direction, the transmission of the second packet sequence in the second direction to be initiated following completion of the transmission of the first packet sequence in the first direction.

Example 168 is the apparatus of Example 167, the source identification frame to be encapsulated in an initial packet of the first packet sequence and an initial packet of the second packet sequence.

Example 169 is the apparatus of any of Examples 167 to 168, the respective initial packets of the first and second packet sequences to be generated for transmission according to a modulation and coding scheme (MCS) for a control physical layer (PHY).

Example 170 is the apparatus of Example 169, the control PHY to comprise a directional multi-gigabit (DMG) control PHY.

Example 171 is the apparatus of any of Examples 169 to 170, an MCS index associated with the MCS for the control PHY to comprise a value of 0.

Example 172 is the apparatus of any of Examples 167 to 171, the respective initial packets of the first and second packet sequences to be generated for transmission using differential binary phase-shift keying (DBPSK).

Example 173 is the apparatus of any of Examples 167 to 172, the fragment frames to be encapsulated in packets generated for transmission according to a modulation and coding scheme (MCS) for an orthogonal frequency division multiplexing (OFDM) PHY, a single carrier (SC) PHY, or a low-power SC PHY.

Example 174 is the apparatus of any of Examples 167 to 173, the fragment frames to be encapsulated in packets generated for transmission using π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 175 is the apparatus of any of Examples 167 to 174, the fragment frames to be encapsulated in packets generated for transmission according to a modulation and coding scheme (MCS) corresponding to an MCS index value that is greater than 0.

Example 176 is the apparatus of any of Examples 167 to 175, the first direction to comprise a direction associated with locations of one or more members of the addressee group, the second direction to comprise a direction associated with at least one other member of the addressee group.

Example 177 is the apparatus of any of Examples 167 to 176, the first and second directions to comprise different respective transmit sectors of the wireless communication device.

Example 178 is the apparatus of any of Examples 167 to 177, comprising means for generating a second frame sequence for transmission from the wireless communication device to the addressee group, the transmission of the second frame sequence to be initiated following the transmission of the first frame sequence.

Example 179 is the apparatus of Example 178, the second frame sequence to comprise a second source identification frame followed by a second series of fragment frames comprising fragments of a second group-addressed fragmented MSDU.

Example 180 is the apparatus of any of Examples 167 to 179, the source identification frame to comprise an identifier associated with the wireless communication device.

Example 181 is the apparatus of Example 180, the identifier to comprise an address associated with the wireless communication device.

Example 182 is the apparatus of Example 181, the address to comprise a medium access control (MAC) address.

Example 183 is the apparatus of any of Examples 181 to 182, the address to be comprised in a transmitting station (STA) address (TA) field of the source identification frame.

Example 184 is the apparatus of any of Examples 167 to 183, each of the series of fragment frames to comprise an identifier associated with the addressee group.

Example 185 is the apparatus of Example 184, the identifier associated with the addressee group to comprise a group address.

Example 186 is the apparatus of Example 185, the group address to be comprised in a respective receiving station (STA) address (RA) field of each of the series of fragment frames.

Example 187 is the apparatus of any of Examples 167 to 186, each of the series of fragment frames to comprise a sequence number (SN) field indicating a sequence number associated with the group-addressed fragmented MSDU.

Example 188 is the apparatus of any of Examples 167 to 187, each one of the series of fragment frames to comprise a respective fragment number (FrN) field indicating a fragment number associated with an MSDU fragment comprised in that fragment frame.

Example 189 is the apparatus of any of Examples 167 to 188, the first and second packet sequences to be transmitted via one or more wireless carrier frequencies of a 60 gigahertz (GHz) frequency band.

Example 190 is the apparatus of any of Examples 167 to 189, the wireless communication device to comprise a personal basic service set control point (PCP) or an access point (AP).

Example 191 is the apparatus of any of Examples 167 to 190, the addressee group to comprise a plurality of stations (STAs).

Example 192 is the apparatus of Example 191, the plurality of STAs to include one or more directional multi-gigabit (DMG) STAs.

Example 193 is the apparatus of any of Examples 191 to 192, the plurality of STAs to include one or more enhanced directional multi-gigabit (EDMG) STAs.

Example 194 is a system, comprising an apparatus according to any of Examples 167 to 193, and at least one radio frequency (RF) transceiver.

Example 195 is the system of Example 194, comprising at least one processor.

Example 196 is the system of any of Examples 194 to 195, comprising at least one RF antenna.

Example 197 is an apparatus, comprising means for identifying a remote device based on source identification frame comprised in a packet received by a wireless communication device according to a modulation and coding scheme (MCS) for a control physical layer (PHY), means for determining a receive antenna configuration to be used for directional reception from the remote device, and means for implementing the receive antenna configuration for receipt of a plurality of packets from the remote device, each one of the plurality of packets to comprise a respective one of a plurality of fragment frames containing fragments of a group-addressed fragmented medium access control service data unit (MSDU).

Example 198 is the apparatus of Example 197, the control PHY to comprise a directional multi-gigabit (DMG) control PHY.

Example 199 is the apparatus of any of Examples 197 to 198, an MCS index associated with the MCS for the control PHY to comprise a value of 0.

Example 200 is the apparatus of any of Examples 197 to 199, the MCS for the control PHY to utilize differential binary phase-shift keying (DBPSK).

Example 201 is the apparatus of any of Examples 197 to 200, each of the plurality of packets to be received according to a modulation and coding scheme (MCS) for an orthogonal frequency division multiplexing (OFDM) PHY, a single carrier (SC) PHY, or a low-power SC PHY.

Example 202 is the apparatus of any of Examples 197 to 201, each of the plurality of packets to be received according to a modulation and coding scheme (MCS) utilizing π/2-binary phase-shift keying (π/2-BPSK), quadrature phase-shift keying (QPSK), π/2-QPSK, staggered QPSK (SQPSK), 16-quadrature amplitude modulation (QAM), π/2-16-QAM, or 64-QAM.

Example 203 is the apparatus of any of Examples 197 to 202, each of the plurality of packets to be received according to a modulation and coding scheme (MCS) corresponding to an MCS index value that is greater than 0.

Example 204 is the apparatus of any of Examples 197 to 203, the wireless communication device to comprise a member of an addressee group for the group-addressed fragmented MSDU.

Example 205 is the apparatus of any of Examples 197 to 204, comprising means for identifying a receive sector to be used for directional reception from the remote device, and means for determining the receive antenna configuration based on the identified receive sector.

Example 206 is the apparatus of any of Examples 197 to 205, the source identification frame to comprise an identifier associated with the remote device.

Example 207 is the apparatus of Example 206, the identifier to comprise an address associated with the remote device.

Example 208 is the apparatus of Example 207, the address to comprise a medium access control (MAC) address.

Example 209 is the apparatus of any of Examples 207 to 208, the address to be comprised in a transmitting station (STA) address (TA) field of the source identification frame.

Example 210 is the apparatus of any of Examples 197 to 209, each of the plurality of fragment frames to comprise an identifier associated with an addressee group for the group-addressed fragmented MSDU.

Example 211 is the apparatus of Example 210, the identifier associated with the addressee group to comprise a group address.

Example 212 is the apparatus of Example 211, the group address to be comprised in a respective receiving station (STA) address (RA) field of each of the plurality of fragment frames.

Example 213 is the apparatus of any of Examples 197 to 212, each of the plurality of fragment frames to comprise a sequence number (SN) field indicating a sequence number associated with the group-addressed fragmented MSDU.

Example 214 is the apparatus of any of Examples 197 to 213, each one of the plurality of fragment frames to comprise a respective fragment number (FrN) field indicating a fragment number associated with an MSDU fragment comprised in that fragment frame.

Example 215 is the apparatus of any of Examples 197 to 214, the plurality of packets to be received via one or more wireless carrier frequencies of a 60 gigahertz (GHz) frequency band.

Example 216 is the apparatus of any of Examples 197 to 215, the remote device to comprise a personal basic service set control point (PCP) or an access point (AP).

Example 217 is the apparatus of any of Examples 197 to 216, the wireless communication device to comprise a station (STA).

Example 218 is the apparatus of Example 217, the STA to comprise a directional multi-gigabit (DMG) STA.

Example 219 is the apparatus of Example 217, the STA to comprise an enhanced directional multi-gigabit (EDMG) STA.

Example 220 is a system, comprising an apparatus according to any of Examples 197 to 219, and at least one radio frequency (RF) transceiver.

Example 221 is the system of Example 220, comprising at least one processor.

Example 222 is the system of any of Examples 220 to 221, comprising at least one RF antenna.

Example 223 is the system of any of Examples 220 to 222, comprising a touchscreen display.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a memory; and
logic for a wireless communication device, at least a portion of the logic comprised in circuitry coupled to the memory, the logic to:
generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU;
encapsulate the frame sequence in packets of a first packet sequence for transmission in a first direction; and
encapsulate the frame sequence in packets of a second packet sequence for transmission in a second direction, the transmission of the second packet sequence in the second direction to be initiated following completion of the transmission of the first packet sequence in the first direction.

2. The apparatus of claim 1, the source identification frame to be encapsulated in an initial packet of the first packet sequence and an initial packet of the second packet sequence.

3. The apparatus of claim 1, the respective initial packets of the first and second packet sequences to be generated for transmission according to a modulation and coding scheme (MCS) for a control physical layer (PHY).

4. The apparatus of claim 3, the fragment frames to be encapsulated in packets generated for transmission according to an MCS for an orthogonal frequency division multiplexing (OFDM) PHY, a single carrier (SC) PHY, or a low-power SC PHY.

5. The apparatus of claim 1, the source identification frame to comprise a transmitting station (STA) address (TA) field containing an address associated with the wireless communication device.

6. The apparatus of claim 1, each of the series of fragment frames to comprise a receiving station (STA) address (RA) field containing an identifier associated with the addressee group.

7. The apparatus of claim 1, each of the series of fragment frames to comprise a sequence number (SN) field indicating a sequence number associated with the group-addressed fragmented MSDU.

8. The apparatus of claim 1, each one of the series of fragment frames to comprise a respective fragment number (FrN) field indicating a fragment number associated with an MSDU fragment comprised in that fragment frame.

9. The apparatus of claim 1, the logic to generate a second frame sequence for transmission from the wireless communication device to the addressee group, the transmission of the second frame sequence to be initiated following the transmission of the first frame sequence.

10. An apparatus, comprising:
a memory; and
logic for a wireless communication device, at least a portion of the logic comprised in circuitry coupled to the memory, the logic to:
identify a remote device based on source identification frame comprised in a packet received according to a modulation and coding scheme (MCS) for a control physical layer (PHY);
determine a receive antenna configuration to be used for directional reception from the remote device; and
implement the receive antenna configuration for receipt of a plurality of packets from the remote device, each one of the plurality of packets to comprise a respective one of a plurality of fragment frames containing fragments of a group-addressed fragmented medium access control service data unit (MSDU).

11. The apparatus of claim 10, an MCS index associated with the MCS for the control PHY to comprise a value of 0.

12. The apparatus of claim 10, each of the plurality of packets to be received according to a modulation and coding scheme (MCS) corresponding to an MCS index value that is greater than 0.

13. The apparatus of claim 10, the wireless communication device to comprise a member of an addressee group for the group-addressed fragmented MSDU.

14. The apparatus of claim 10, the logic to:
identify a receive sector to be used for directional reception from the remote device; and
determine the receive antenna configuration based on the identified receive sector.

15. A system, comprising:
the apparatus of claim 10; and
at least one radio frequency (RF) transceiver;

16. At least one non-transitory computer-readable storage medium comprising a set of instructions that, in response to being executed at a wireless communication device, cause the wireless communication device to:
generate a frame sequence for transmission to an addressee group of a group-addressed fragmented medium access control service data unit (MSDU), the frame sequence to comprise a source identification frame followed by a series of fragment frames comprising fragments of the group-addressed fragmented MSDU;
encapsulate the frame sequence in packets of a first packet sequence for transmission in a first direction; and
encapsulate the frame sequence in packets of a second packet sequence for transmission in a second direction, the transmission of the second packet sequence in the second direction to be initiated following completion of the transmission of the first packet sequence in the first direction.

17. The at least one non-transitory computer-readable storage medium of claim 16, the source identification frame to be encapsulated in an initial packet of the first packet sequence and an initial packet of the second packet sequence.

18. The at least one non-transitory computer-readable storage medium of claim 16, the respective initial packets of the first and second packet sequences to be generated for transmission according to a modulation and coding scheme (MCS) corresponding to an MCS index value of 0.

19. The at least one non-transitory computer-readable storage medium of claim 16, the fragment frames to be encapsulated in packets generated for transmission according to a modulation and coding scheme (MCS) corresponding to an MCS index value that is greater than 0.

20. The at least one non-transitory computer-readable storage medium of claim 16, comprising instructions that, in response to being executed at the wireless communication device, cause the wireless communication device to generate a second frame sequence for transmission from the wireless communication device to the addressee group, the transmission of the second frame sequence to be initiated following the transmission of the first frame sequence.

21. At least one non-transitory computer-readable storage medium comprising a set of instructions that, in response to being executed at a wireless communication device, cause the wireless communication device to:
identify a remote device based on source identification frame comprised in a packet received according to a modulation and coding scheme (MCS) for a control physical layer (PHY);
determine a receive antenna configuration to be used for directional reception from the remote device; and
implement the receive antenna configuration for receipt of a plurality of packets from the remote device, each one of the plurality of packets to comprise a respective one of a plurality of fragment frames containing fragments of a group-addressed fragmented medium access control service data unit (MSDU).

22. The at least one non-transitory computer-readable storage medium of claim 21, the MCS for the control PHY to utilize differential binary phase-shift keying (DBPSK).

23. The at least one non-transitory computer-readable storage medium of claim 21, each of the plurality of packets to be received according to a modulation and coding scheme (MCS) for an orthogonal frequency division multiplexing (OFDM) PHY, a single carrier (SC) PHY, or a low-power SC PHY.

24. The at least one non-transitory computer-readable storage medium of claim 21, the wireless communication device to comprise a member of an addressee group for the group-addressed fragmented MSDU.

25. The at least one non-transitory computer-readable storage medium of claim 21, comprising instructions that, in response to being executed at the wireless communication device, cause the wireless communication device to:
identify a receive sector to be used for directional reception from the remote device; and
determine the receive antenna configuration based on the identified receive sector.
